(19) United States
(12) Patent Application Publication
(10) Pub. No.: US 2015/0214647 A1
(43) Pub. Date: Jul. 30, 2015

(54) CARD CONNECTOR ASSEMBLY WITH SUBSIDIARY COMPONENT

(71) Applicant: FOXCONN INTERCONNECT TECHNOLOGY LIMITED, Grand Cayman (KY)

(72) Inventors: LU-LU SHA, Kunshan (CN); DING-BING FAN, Kunshan (CN); JI-CHAO WANG, Kunshan (CN); GUO-HUA ZHANG, Kunshan (CN); QI-SHENG ZHENG, Kunshan (CN)

(21) Appl. No.: 14/605,980

(22) Filed: Jan. 26, 2015

(30) Foreign Application Priority Data
Jan. 24, 2014 (CN) 201420044308.1

(51) Int. Cl. H01R 12/72; H01R 13/629; H01R 13/502

(52) U.S. Cl. CPC H01R 12/721; H01R 13/502; H01R 13/629

(57) ABSTRACT

A card connector assembly includes a card connector and a pick-up cap attached to the card connector. The card connector includes an insulating housing and a plurality of conductive terminals The insulating housing has a base portion, a mating frame and a mating cavity formed in the mating frame. The conductive terminals have contacting sections and soldering sections. The pick-up cap has an adsorption portion and a retaining plate extending downwardly from a middle area of the adsorption portion and inserted into the mating cavity. The retaining plate has an interference portion protruding out of the retaining portion to abut against an inner surface of the mating frame.

### BACKGROUND OF THE INVENTION

1. Field of the Invention

The present invention generally relates to a card connector assembly, and more particularly to a card connector assembly which has a card connector and a pick-up cap attached to the card connector.

2. Description of Related Art

Chinese patent No. 201252181 discloses a card connector having a mounting plane mounted onto a printed circuit board and a mating face being perpendicular to the mounting plane and mated with a complementary electronic card. In use, the complementary electronic card is inserted into the card connector along a direction parallel to the mounting plane. Nowadays, to meet different requirement of users, a vertical type card connector is developed. The vertical card connector comprises an insulating housing, a plurality of conductive terminals secured in the insulating housing and a plurality retaining plate fixed in the insulating housing and fixing the card connector onto a printed circuit board. The insulating housing has a base portion and a mating frame having a mating cavity recessed therein and extending upwardly from the base portion. The conductive terminals have contact portions exposed to the mating cavity and soldering portions extending out of the insulating housing to be soldered to the printed circuit board. As we all know, the card connector is becoming smaller and smaller, and the vertical type card connector is fabricated as tabular shape. The vertical type card connector is not easy to be grabbed by a mechanical arm when fixed to an electronic product in automatic assembly process.

In view of the foregoing, a card connector assembly is able to overcome the drawbacks described aforementioned would be desirable.

### SUMMARY OF THE INVENTION

Accordingly, an object of the present invention is to provide a card connector assembly, the card connector assembly has a pick-up cap attached to a card connector.

In order to achieve the object set forth, a card connector assembly is provided with a card connector and a pick-up cap attached to the card connector. The card connector comprises an insulating housing and a plurality of conductive terminals secured in the insulating housing. The insulating housing has a base portion, a mating frame extending upwardly from the base portion and a mating cavity formed in the mating frame. The conductive terminals have contacting sections exposed to the mating cavity and soldering sections extending out of the insulating housing. The pick-up cap has an adsorption portion and a retaining plate extending downwardly from a middle area of the adsorption portion and being inserted into the mating cavity. The retaining plate has an interference portion protruding out of the retaining portion to abut against an inner surface of the mating frame.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a card connector assembly mounted on a printed circuit board of the present invention;

FIG. 2 is a perspective view of a pick-up cap separated from a card connector of the card connector assembly in FIG. 1;

FIG. 3 is a perspective view of the card connector assembly separated from the printed circuit board in FIG. 1;

FIG. 4 is an exploded perspective view of the card connector assembly and the printed circuit board in FIG. 1;

FIG. 5 is another exploded perspective view of the card connector assembly and the printed circuit board in FIG. 1; and

FIG. 6 is a sectional perspective view along line 6-6 of the card connector assembly mounted on the printed circuit board in FIG. 1.

### DETAILED DESCRIPTION OF THE INVENTION

Reference will now be made in detail to the preferred embodiment of the present invention.

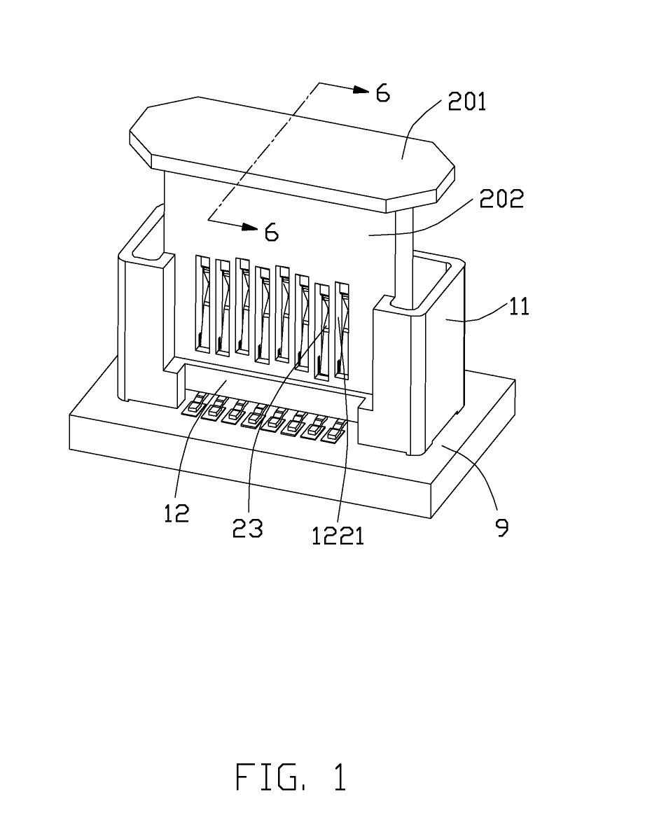

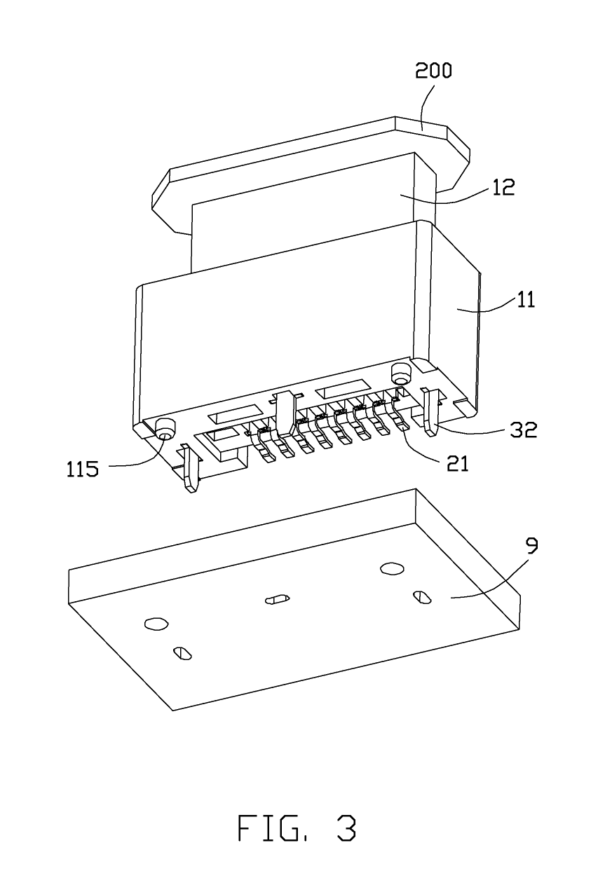

FIG. 1 to FIG. 6 are taken to describe a card connector assembly provided with a vertical card connector 100 and a pick-up cap 200 attached to the card connector 100.

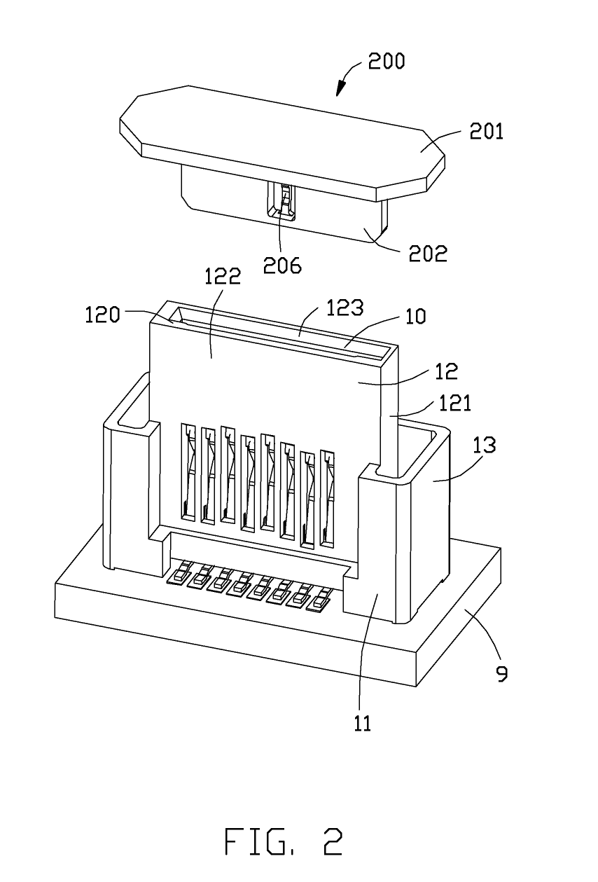

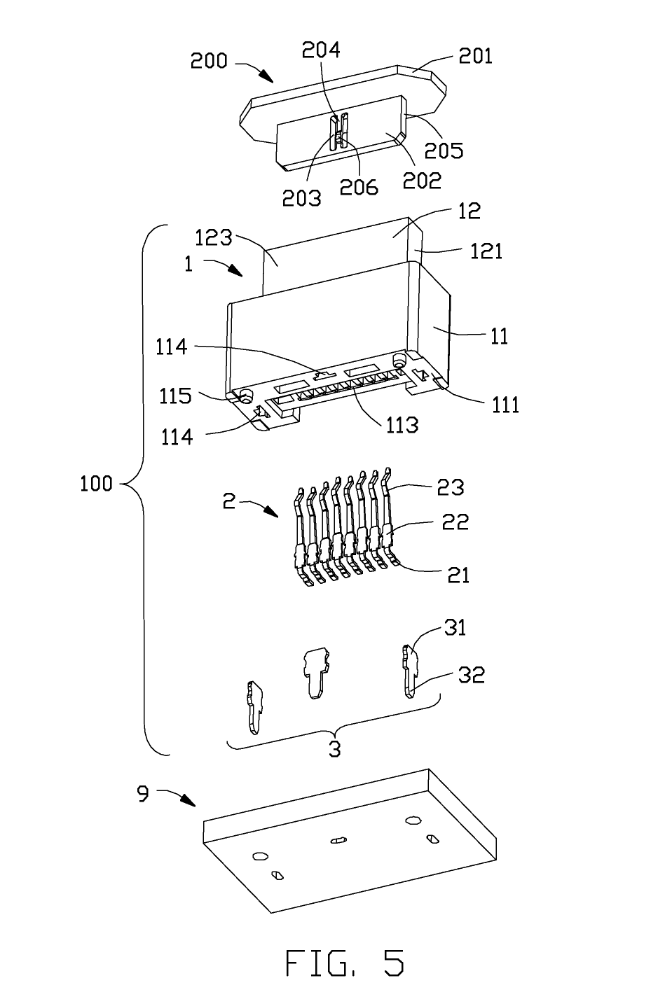

Referring to FIG. 2 and FIG. 5, the pick-up cap 200 has a tabulate adsorption plate 201 and a retaining plate 202 extending downwardly and vertically from a middle area of a bottom face of the adsorption plate 201. A upper face of the adsorption plate 201 is a smooth plane. The retaining plate 202 configured as a schistose structure has two side portions 205 disposed at two opposite sides thereof.

The retaining plate 202 defines an opening 203 in a middle area thereof and a bridge portion 204 extending along an upper to lower direction and connecting the upper side and the lower side of the opening 203. The bridge portion 204 is formed with an interference portion 206 in a middle position protruding out of the retaining plate 202. The pick-up cap 200 may be fabricated of a variety of different materials which can interfere with the card connector 100 including LCP plastic material.

Referring to FIG. 2 and FIG. 4 to FIG. 6, the card connector 100 has an insulating housing 1, a plurality of conductive terminals 2 secured in the insulating housing 1 and a plurality of fixing plates 3 secured in the insulating housing 1 and fixing the card connector 1 onto a printed circuit board 9. The insulating housing 1 has a base portion 11 mounted onto the printed circuit 9, a mating frame 12 extending upwardly and vertically from a top face of the base portion 11 and a mating cavity 10 formed in the mating frame 12. The base portion 11 has opposite a lower face 111 at a bottom face thereof and an upper face 112 at a top face thereof The mating frame 12 extends upwardly from the upper face 112 and has a mating face 120 atop the mating frame 12. The mating frame 12 has two narrow side walls 121 and opposite a front wall 122 and a rear wall 123 connecting with the two side walls 121, and all the walls 121, 122, 123 cooperatively defining the mating cavity 10. The mating cavity 10 is recessed downwardly from the mating face 120 and continuously extends to the lower face 111 of the base portion 11. The base portion 11 defines a plurality of fixing holes 113 upwardly and downwardly running through the upper and lower face 112, 111 thereof, a plurality of retaining slots 114 recessed upwardly from the lower face 111 and two mounting posts 115 protruding downwardly from the lower face 111 and located in two corners thereof The fixing holes 113 are arranged in one row along a longitudinal direction same as the front wall 112 and are used for retaining the conductive terminals 2 There are three retaining slots 114 disposed at a peripheral area of the fixing holes 113 which appear as triangular arrangement. The front wall 122 has a plurality of receiving grooves 1221 running through the front and rear face thereof and communicating with the mating cavity 10 and the fixing holes 113. The base portion 11 defines a protecting wall 13 extending upwardly from a peripheral area thereof and surrounding the rear wall 123 and the two side walls 121 and connecting with the left and right sides of the front wall 122. Thus, the card connector 100 of the present invention can stably mounted on the printed circuit board 9.

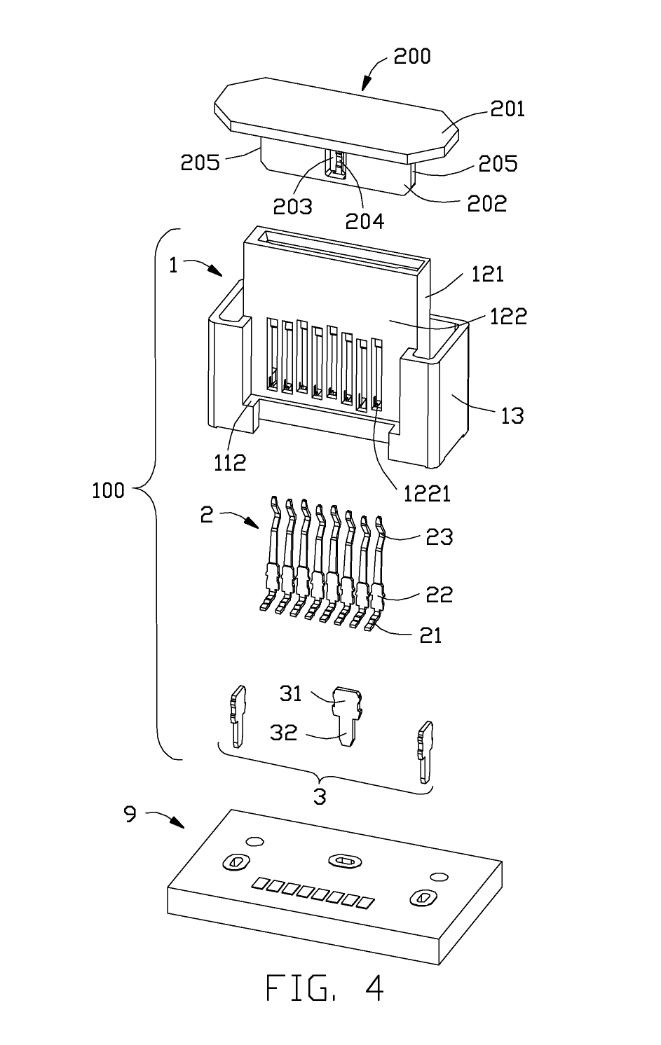

Referring to FIG. 4, each of the conductive terminals 2 has a retaining section 22 retained in the fixing hole 113, an elastic contacting section 23 extending upwardly from one end of the retaining section 23 and a soldering section 21 extending downwardly initially and then outwardly in a horizontal direction. The soldering sections 21 are soldered onto an upper surface of the printed circuit board 9. The contacting sections 23 are received in the receiving grooves 1221 and partly protruding into the mating cavity 10 to contact with the complementary electronic card (not shown).

There are three fixing plates 3 provided and fixed in the retaining slots 114. Each of the fixing plates 3 is configured as “T” shaped and has a fixing section 31 fixed in the retaining slot 114 and a soldering leg 32 extending downwardly from the fixing section 31 and soldered onto the printed circuit board 9.

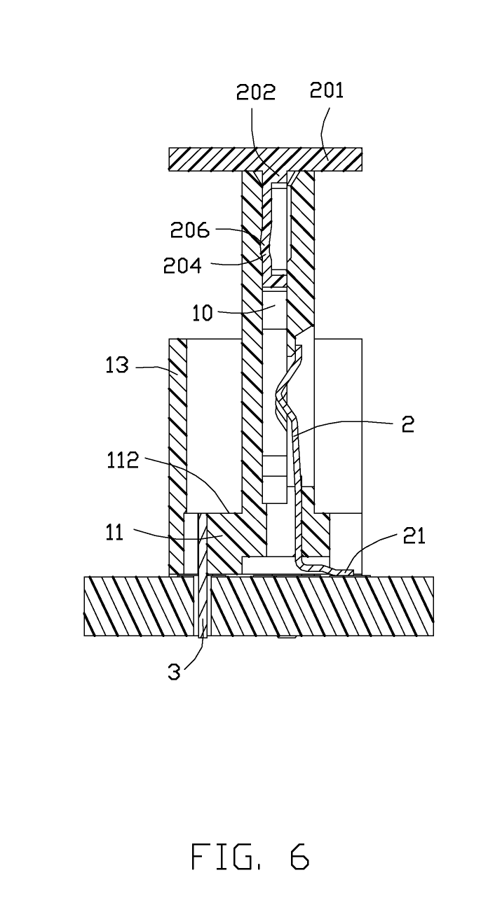

Referring to FIG. 6, before the card connector 100 is packaged, the pick-up cap 200 is attached to the card connector 100 with the retaining plate 202 inserted into the mating cavity 10, while the lower end of the retaining plate 202 is not in touch with the contacting sections 23 of the conductive terminals 2. The two side portions 205 of the retaining plate 202 interfere with the two side walls 121 of the mating frame 12, and the interference portion 206 of the bridge portion 204 interferes with inner surfaces of the front or rear walls 122, 123. Thus, it is convenient for the mechanical arm to catch the card connector 100 by absorbing the adsorption plate 201 of the pick-up cap 200 in automatic fabrication process. It is also convenient to take the pick-up cap 200 off the card connector 100 after the card connector 100 is mounted on the printed circuit board 9.

FIG. 1 to FIG. 6 are taken to describe a preferred embodiment of the present invention, however some other embodiments also can obtain the object that is convenient for the automatic fabrication process. For example, another cap 200 is provided with an retaining portion extending downwardly from the peripheral area of the lower face of the adsorption portion and configured as a tubular structure with a receiving space thereamong. The retaining portion is formed with the interference portion which extends inwardly to the receiving space to interferes with an outer surface of the mating frame 12. Further more, the retaining portion defines at least one inclined face at a free end opposite to the adsorption portion, the width of the free end is smaller than an upper part of the retaining portion. It is also convenient for the mechanical arm to catch the card connector 100.

It is to be understood, however, that even though numerous characteristics and advantages of the present invention have been set forth in the foregoing description, together with details of the structure and function of the invention, the disclosure is illustrated only, and changes may be made in detail, especially in matters of shape, size, and arrangement of parts within the principles of the invention to the full extent indicated by the broad general meaning of the terms in which the appended claims are expressed.

We claim:

1. A card connector assembly comprising:
a vertical card connector comprising an insulating housing and a plurality of conductive terminals secured in the insulating housing, the insulating housing having a base portion, a mating frame extending upwardly from the base portion and a mating cavity formed in the mating frame, the conductive terminals have contacting sections exposed to the mating cavity and soldering sections extending out of the insulating housing; and
a pick-up cap detachably attached to the card connector;
wherein the pick-up cap has an adsorption portion and a retaining plate extending downwardly from a middle area of the adsorption portion and being inserted into the mating cavity, the retaining plate has an interference portion protruding out of the retaining portion to abut against an inner surface of the mating frame.

2. The card connector assembly as claimed in claim 1, wherein the retaining plate defines an opening in a middle area and a bridge portion disposed in the opening and connecting with an upper side and a lower side of the opening, and the interference portion protrudes outwardly from a middle portion of the bridge portion.

3. The card connector assembly as claimed in claim 1, wherein the mating frame has two narrow side walls and opposite a front wall and a rear wall connecting with the two side walls, and all of these walls surround the mating cavity, and the interference portion elastically abut against the inner surface of the rear wall.

4. The card connector assembly as claimed in claim 3, wherein the retaining plate has two side portions at two sides, the two side portions interfere with the two side walls of the mating frame.

5. The card connector assembly as claimed in claim 3, wherein the front wall defines a plurality of receiving grooves communicating with the mating cavity, and the contacting sections of the conductive terminals are received in the receiving grooves and partly protrude into the mating cavity.

6. The card connector assembly as claimed in claim 3, wherein the mating frame has a mating face atop the mating frame from which the mating cavity is recessed downwardly, the base portion has a lower face to which the mating cavity extending downwardly.

7. The card connector assembly as claimed in claim 6, wherein the base portion defines a plurality of fixing holes upwardly and downwardly running through the base portion and communicating with the mating cavity and the receiving grooves, the conductive terminals have retaining sections fixed in the fixing holes, the contacting section extends upwardly from one end of the retaining section, and the soldering section extends downwardly initially and then outwardly in a horizontal direction from the other end of the retaining section.

8. The card connector assembly as claimed in claim 7, wherein the fixing holes are formed in a middle area of the base portion in one row, and the base portion defines retaining slots disposed at a peripheral area of the fixing holes and appearing as triangulate arrangement.

9. The card connector assembly as claimed in claim 8, wherein the card connector comprises lots of “T” shaped retaining plates retained in the retaining slots.

10. A card connector assembly, comprising:
a card connector comprising an insulating housing and a plurality of conductive terminals secured in the insulating housing, the insulating housing formed with a base portion and a mating frame extending upwardly from the base portion and provided with a mating cavity recessed therein, the conductive terminal having a contacting portion exposed to the mating cavity and a soldering portion extending out of the insulating housing; and
a cap portion attached to the card connector;
wherein the cap portion has a tabulate adsorption portion with a smooth top surface and a retaining portion extending downwardly from a bottom surface of the adsorption portion, the retaining portion defines at least one opening and a corresponding interference portion received in the opening and protruding out of the opening to interfere with the mating frame, the interference portion is connected with an inner side of the opening.

11. The card connector assembly as claimed in claim 10, wherein the retaining portion extends downwardly and vertically from a middle area of the adsorption portion and is inserted into the mating cavity of the insulating housing, the interference portion abuts against an inner surface of the mating frame.

12. The card connector assembly as claimed in claim 11, wherein the opening is disposed in a middle area of the retaining portion, the interference portion connects with an upper and a lower sides of the opening and has a protruding portion in a middle portion thereof.

13. The card connector assembly as claimed in claim 10, wherein the interference portion extends downwardly from a peripheral area of the bottom surface of the adsorption portion and is configured as a tubular structure with a receiving space thereamong, the interference portion extends inwardly to the receiving space to abut against an outer surface of the mating frame.

14. The card connector assembly as claimed in claim 10, wherein the retaining portion defines at least one inclined face at a free end opposite to the adsorption portion, the width of the free end is smaller than an upper part of the retaining portion.

15. A card connector assembly comprising:
an insulative housing defining a slender mating cavity extending along a longitudinal direction and communicating with an exterior in a vertical direction perpendicular to said longitudinal direction;
a plurality of contacts disposed within the housing and located by one side of the mating cavity in a transverse direction, which is perpendicular to said longitudinal direction and said vertical direction, with contacting sections exposed within the mating cavity and soldering sections located on a bottom side of the housing;
a cap portion detachably mounted to the housing and including an upper adsorption plate upwardly exposed to the exterior and a lower retaining plate unitarily extending downwardly from the adsorption plate and adapted to be downwardly inserted into the mating cavity, a thickness of said retaining plate being similar to a width of said mating cavity in the transverse direction so as to have said retaining plate snugly and compliantly received within the mating cavity, wherein
said retaining plate is equipped with an interference portion which is deflectable in the transverse direction and protrudes beyond a corresponding surface of the retaining plate in the transverse direction to interfere with the housing.

16. The card connector assembly as claimed in clam 15, wherein a thickness of said interference portion is smaller than the thickness of the retaining plate.

17. The card connector assembly as claimed in clam 15, wherein said retaining plate forms an opening in which said interference portion is located so as to increase flexibility of said interference portion.

18. The card connector assembly as claimed in claim 15, wherein the housing includes a protection wall leaving a cutout to allow tails of the contacts to horizontally extend in the transverse direction.

19. The card connector assembly as claimed in claim 15, wherein the housing includes four sides, tails of the contacts extending along one side and three fixing plates are located on the other three sides for mounting the housing to a printed circuit board.

20. The card connector assembly as claimed in claim 15, wherein said interference portion defines two opposite ends fixed to the retaining plate in the vertical direction as a bridge structure.
